(19) United States
(12) Patent Application Publication
(10) Pub. No.: US 2014/0220510 A1
(43) Pub. Date: Aug. 7, 2014

(54) DENTAL PARTIAL

(71) Applicant: ORAL ARTS LABORATORY, INC., Huntsville, AL (US)

(72) Inventor: Marilyn Barton, Huntsville, AL (US)

(73) Assignee: Oral Arts Laboratory, Inc., Huntsville, AL (US)

(21) Appl. No.: 13/757,476

(22) Filed: Feb. 1, 2013

(51) Int. Cl. A61C 13/103; A61C 9/00; A61C 13/097; A61C 13/267; A61C 13/01

(52) U.S. Cl. CPC A61C 13/1009; A61C 13/267; A61C 13/04; A61C 13/097; A61C 9/00
USPC 433/178; 433/191; 433/199.1

(57) ABSTRACT

A dental partial includes a prosthetic tooth with an anchor extending from the tooth, where the anchor and the tooth are a single unitary structure. The anchor is embedded in a base of the dental partial, where the base conforms to the shape of a patient's mouth. The prosthetic tooth has a lingual surface and a facial surface, and the anchor extends from at least one of the lingual and/or facial surfaces of the prosthetic tooth.

### BACKGROUND OF THE INVENTION

a. Field of the Invention

The current invention relates to dental partials.

b. Background of the Invention

Many people will lose a tooth for one reason or another, and people with one or more missing teeth will often resort to prosthetic teeth for aesthetic and functional purposes. A missing tooth is often visible, and can impart an image that many people find undesirable, such as an unsophisticated or ruffian image. Food is typically chewed between opposing upper and lower teeth, but a missing tooth leaves a gap that interferes with chewing and biting actions.

There are many ways to secure a prosthetic tooth in a person's mouth. If one single tooth is missing, and there are stable teeth on either side of the missing tooth, a bridge can be used. The bridge secures the prosthetic tooth to the adjoining stable teeth. A bridge is generally a permanent attachment, such that an individual cannot remove the prosthetic tooth at will. Dentures are often used where all of a person's teeth are missing, or at least all of either the top teeth or the bottom teeth. With dentures, the prosthetic teeth are secured to a base that fits the contours of the person's mouth. Dentures are often removable, so the user can take them out every night or as needed for cleaning, comfort, or other reasons. However, permanent dentures are also available.

A removable partial denture, referred to as just a partial in this description, is a removable replacement missing natural teeth, gingival tissue, and/or supporting bone when one or more natural teeth still remain. A partial is a device with one or more prosthetic teeth secured to a base, where the base is usually either metallic or polymeric, and the prosthetic teeth are permanently secured to the base. The base is typically secured to remaining natural teeth, but the attachment is usually temporary. The person can remove the partial by hand, and then re-position the partial in their mouth when desired. There are other types of partial dentures that can be permanently installed.

The prosthetic teeth are typically made of a hard material that will withstand chewing. In many cases, a prosthetic tooth is sized, shaped, and colored to match a person's natural teeth, so others will not notice the tooth is prosthetic. In other cases, a prosthetic tooth will not match the natural teeth, such as when the tooth is positioned out of sight with the person's mouth, or when the user desires a prosthetic tooth that stands out, such as a gold tooth.

Prosthetic teeth are made from many different materials. Ivory, porcelain, and metals have been used historically, and can still be used today. Acrylic resins and ceramics are also used for prosthetic teeth, and it is possible to use other materials. The prosthetic tooth should be strong enough to withstand chewing, and durable enough to last for an extended period.

Prosthetic teeth can be secured to a base in several different ways. Holes or cavities can be formed in the bottom of the prosthetic tooth, where the base contacts the prosthetic tooth, and the material of the base can be formed into that hole or cavity to secure the prosthetic tooth to the base. Other known methods can be used to secure the prosthetic tooth to the base using known techniques.

In many cases, the connection between the prosthetic tooth and the base can be a challenge. For example, in cases where the patient's upper and lower bite are close together, there is very little room for all the components of the partial, such as the prosthetic tooth, framework, and/or base material. In these cases, it can be difficult to anchor the prosthetic tooth in place during the extreme forces of mastication. In patients with normal bites, the prosthetic tooth can be affixed via conventional methods of acrylic bonding to the prosthetic tooth surface, or through the use of “diatoric” holes for added retention. The attachment needs to be durable, because a prosthetic tooth is often used on a daily basis for an extended period, such as several years. Time, effort, and money are required to attach an anchor to a prosthetic tooth, and any attachment has the potential to fail. The prosthetic tooth and the anchor are typically made from different materials, and connections between different materials can be susceptible to special considerations, such as thermal stress and/or increased corrosion rates at the connection.

### BRIEF SUMMARY OF THE INVENTION

A dental partial includes a prosthetic tooth with an anchor extending from the tooth, where the anchor and the tooth are a single unitary structure. The anchor is embedded in a base of the dental partial, where the base conforms to the shape of a patient's mouth. The prosthetic tooth has a lingual surface and a facial surface, and the anchor extends from at least one of the lingual and/or facial surfaces of the prosthetic tooth.

### BRIEF DESCRIPTION OF THE DRAWINGS

FIG. 1 is a perspective view of a dental partial positioned over a person's mouth, where the partial is ready to be inserted into place.

FIG. 2 is an upper perspective view of one embodiment of a prosthetic tooth with unitary anchors.

FIG. 3 is a lower perspective view of one embodiment of a prosthetic tooth with unitary anchors.

FIG. 4 is a side sectional view of a prosthetic tooth an anchor encased in a base.

### DETAILED DESCRIPTION

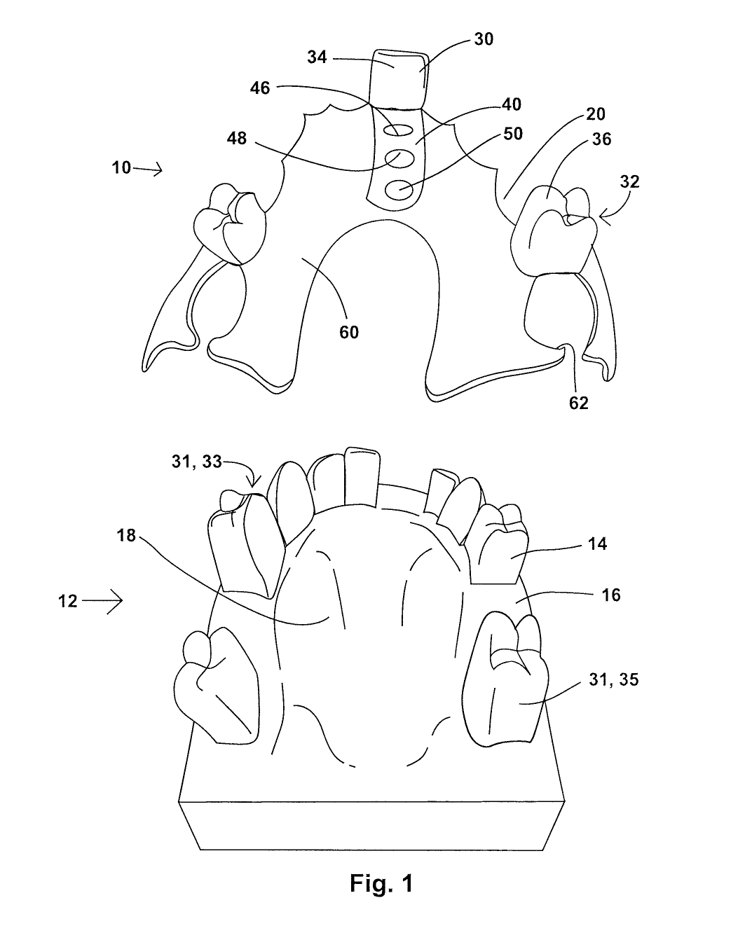

A dental partial 10 comprises two primary components; (1) at least one prosthetic tooth 30 and (2) a base 60, as seen in FIG. 1. The partial 10 fits within a patient's mouth 12 such that the prosthetic tooth 30 is positioned in place of a missing tooth. The patient's mouth 12 also includes at least one natural tooth 14, and prosthetic teeth 30 are positioned adjacent to natural teeth 14 when the partial 10 is in place. The teeth 14, 30 extend outward from the patient's gums 16. The patient's mouth 12 also comprises an inner surface 18, which the palate or the floor of the mouth 12, as well as at least part of the gums 16. The partial 10 is removable, which means the patient can remove the partial 10 without any special tools, so the patient can simply grasp the partial 10 with a hand and remove it. The patient can also re-insert the partial 10 with a hand, and without the use of any special tools.

The dental partial 10 comprises at least one prosthetic tooth 30, and in some embodiments the dental partial 10 comprises a. plurality of prosthetic teeth 30. The dental partial 10 also comprises at least one gap 20 for a natural tooth 14, and in many embodiments the dental partial 10 comprises a plurality of gaps 20 for natural teeth 14. The gap 20 can be at the end of the partial 10, such as if the partial 10 were to accommodate natural wisdom teeth 14. The base 60 can be made from a variety of materials, such as chrome metal, flexible resins or nylons, acrylics, or a combination of the above.

### Prosthetic Tooth

The prosthetic tooth 30 is made from a hard material, which can comprise zirconia, acrylic resins, ceramics, metals, or other materials. The prosthetic tooth 30 can primarily comprise zirconia, but additives can also be present, such as dyes or colorants, surfactants, and other substances. Additives and other substances can also be present if the prosthetic tooth 30 primarily comprises a material other than zirconia. Zirconia does not adhere well to the flexible resins or nylons, or to the acrylic that are sometimes used in the base 60, so some form of mechanical connection between the prosthetic tooth 30 and the base 60 can improve the strength of the connection.

Each of the natural and prosthetic teeth 14, 30 has a facial surface 32, which is the surface facing outward, and a lingual surface 34, which is the surface facing inward or toward the tongue when the mouth 12 is closed. The facial surface 32 and the lingual surface 34 are generally opposite each other. The teeth 14, 30 also comprise a mesial surface 33 and a distal surface 35 positioned between the lingual and facial surfaces 34, 32. The mesial and distal surfaces 33, 35 are the sides that come in contact with adjacent teeth 14, 30, and the mesial surface 33 faces the front of the mouth 12. The distal surface is pointing away from the midline of the mouth 12, and on the opposite side of the tooth 14, 30 as the mesial surface 35. The facial, mesial, lingual, and distal surfaces 32, 33, 34, 35 are all side surfaces 31 of the tooth 14, 30.

The teeth 14, 30 also comprise an incisal or occlusal surface 36 and a palatal surface 38. The occlusal surface 36 which is the portion of the tooth 14, 30 furthest from the gums 16, or the biting surface, and the palatal surface 38 is the part of the tooth 14, 30 closest to the gums 16. The tooth occlusal and palatal surfaces 36, 38 are generally opposite each other. The gums 16 are adjacent to the tooth palatal surface 38, and in this description the gums 16 are described as being below the tooth palatal surface 38, even though it is understood that the gums 16 are physically above the tooth palatal surface 38 for the upper teeth 14, 30. This terminology is used for simplicity and to reduce repetitive descriptions of “under the tooth palatal surface 38 for the lower teeth 14, 30 and over the tooth palatal surface 38 for the upper teeth 14, 30.”

An anchor 40 extends from at least one the prosthetic tooth 30. The partial 10 may have a plurality of prosthetic teeth 30, at least one of which comprises an anchor 40 and some of which don't. Alternatively, all the prosthetic teeth 30 in the partial 10 can comprise an anchor 40. The anchor 40 is unitary with the prosthetic tooth 30, which means the anchor 40 and the prosthetic tooth 30 are one single piece with no break or joint between them. A line can be drawn to differentiate the anchor 40 and the prosthetic tooth 30, but there is no break or joint at that line. Therefore, the anchor 40 and the prosthetic tooth 30 are primarily made of the same material. There can be gradients or gradual changes in the composition of a material, but there is no sharp, distinct dividing line between the prosthetic tooth 30 and the anchor 40 with primarily different compositions on opposite sides of that line. For example, the prosthetic tooth 30 may comprise a dye or colorant, and that dye or colorant may not be present in the anchor 40, but the primary composition of both the prosthetic tooth 30 and the anchor 40 remain the same.

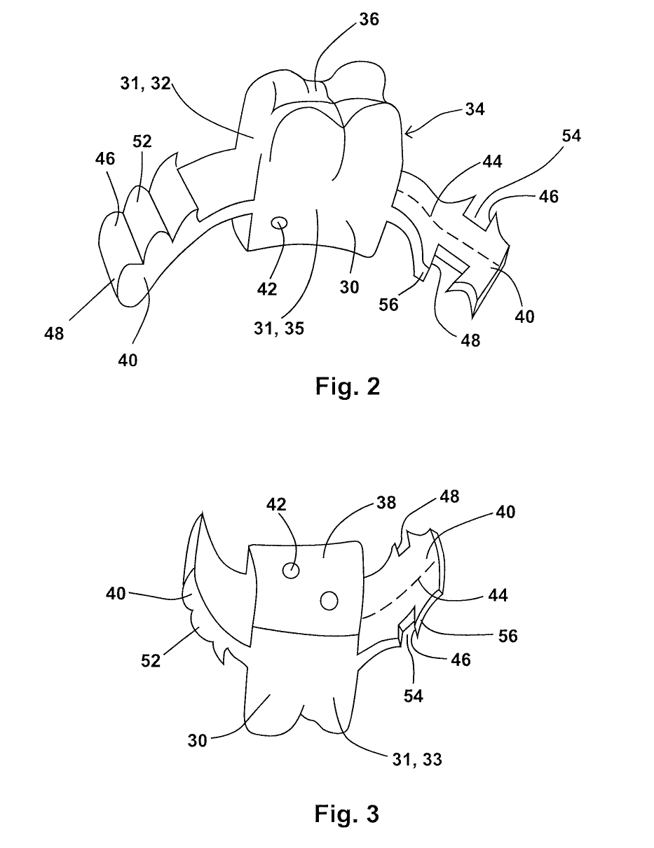

The anchor 40 extends from at least one of the facial side 32 or the lingual side 34 of the prosthetic tooth 30, and in some embodiments there can be an anchor 40 extending from both the facial and lingual side 32, 34 of the prosthetic tooth 30, as seen in FIGS. 2 and 3, with continuing reference to FIG. 1. Embodiments with two anchors 40 extending from opposite sides of the prosthetic tooth 30 are generally used for molars, or other teeth which are not visible when a person smiles, but more than one anchor 40 can be used with any prosthetic tooth 30. A prosthetic tooth 30 with two anchors 40 extending from opposite sides tends to be more firmly affixed to the base 60, as described in more detail below.

In some embodiments, the partial 10 will include a prosthetic tooth 30 replacing an incisor or canine tooth of the patient, such that the gums 16 of the patient under the prosthetic tooth palatal surface 38 are visible when the patient smiles. If the base 60 of the partial 10 extends from the facial side 32 of a prosthetic incisor or canine, that portion of the base 60 would be visible in the patient's smile. A partial 10 where the base 60 does not extend from the facial side 32 of an incisor or canine tooth may be preferable, because the fact that the patient is wearing a partial 10 would be less evident, or not evident at all, to other people. However, there is less material for securing a prosthetic tooth 30 to the base 60 when the base 60 does not extend from the facial side 38 of the prosthetic tooth 30. In general, the more secure the attachment of the prosthetic teeth 30 to the base 60, the better. In some embodiments, the entire base 60 is posterior to the facial surface 32 of the patient's incisor tooth 14, 30, regardless of whether the partial 10 includes a prosthetic incisor tooth 30 or not. The patient may want to partial 10 to remain discrete regardless of whether a prosthetic incisor tooth 30 is needed, so keeping the entire base 60 posterior to the incisor facial surface 32 can aid in discretion. In some embodiments, the entire base 60 is posterior to all the incisor teeth 14, 30.

In some embodiments, the materials of the prosthetic tooth 30 and the base 60 tend to resist adhesion, so a secure mechanical connection is desirable. One type of mechanical connection is to produce a cavity 42 in the prosthetic tooth palatal surface 38, and fill the cavity 42 with the material of the base 60. The cavity 42 is shown in FIGS. 2 and 3, with continuing reference to FIG. 1. This serves to mechanically connect the prosthetic tooth 30 and the base 60. The cavity 42 could also be positioned on a side surface 31 of the prosthetic tooth 30, such as the lingual or facial surface 34, 32, as long as the base 60 contacts the prosthetic tooth 30 at the location of the cavity 42. The base 60 generally contacts the prosthetic tooth 30 along the palatal surface 38, or along the sides near the palatal surface 38, so most of the prosthetic tooth 30 stands proud of the base 60.

In some embodiments, the cavity 42 is narrower at the surface of the prosthetic tooth 30 and wider within the body of the prosthetic tooth 30, so the material of the base 60 within the cavity 42 is too large to pass through the cavity opening at the surface of the prosthetic tooth 30. This can increase the strength of the mechanical union between the base 60 and prosthetic tooth 30. In alternate embodiments, there are two or more cavities 42 in a prosthetic tooth 30, and the cavities 42 penetrate into the prosthetic tooth 30 at different angles. The material of the base 60 cannot pull straight out of all the cavities 42 at the same time, because the cavities 42 are not aligned, and this technique can also increase the strength of the mechanical union. It is also possible to utilize a single, straight cavity 42.

At least one prosthetic tooth 30 comprises an anchor 40 extending from the prosthetic tooth 30. The anchor 40 often extends from the lingual side 34 of the prosthetic tooth 30 so the anchor 40 is hidden from view within the patient's mouth 12. In some embodiments, the anchor 30 only extends from the lingual side 34 of the prosthetic tooth 30, especially for incisors or canines, because an anchor 40 extending from the facial side 32 would be visible. Also, the base 60 may not be present on the facial side 32 of the prosthetic tooth 30, so the anchor 40 could not connect to the base 60 on the facial side 32. In some embodiments, the anchor 40 extends from a prosthetic tooth side surface 31 at or near the prosthetic tooth palatal surface 38.

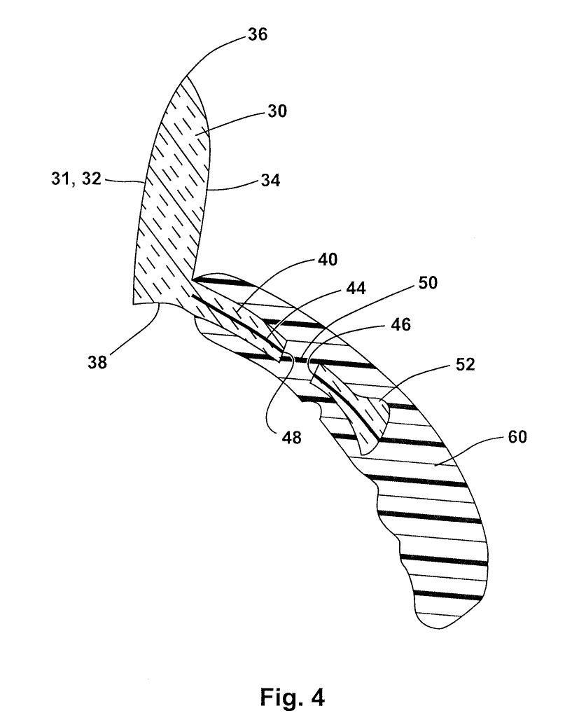

The anchor 40 has a central axis 44, which is an imaginary line at the centermost part of the anchor 40 that extends from where the anchor 40 connects to the prosthetic tooth 30 to the opposite end of the anchor 40. The central axis 44 is visible in FIG. 4, with continuing reference to FIGS. 1-3. The central axis 44 bends and turns with any bends and turns of the anchor 40.

The anchor 40 comprises a catch surface 46, which is a surface of the anchor 40 that faces at least partially towards the prosthetic tooth 30 relative to the central axis 44. This means the catch surface 46 provides a purchase point, so if the anchor 40 were encased in a material, that material would have to give way around the catch surface 46 to pull the prosthetic tooth 30 free of that material. The anchor 40 also comprises a push surface 48, which is a surface of the anchor 40 that faces at least partially away from the prosthetic tooth 30 relative to the central axis 44. The end of the anchor 40 opposite from the connection to the prosthetic tooth 30 is a push surface 48, because it faces away from the prosthetic tooth 30. The catch surface 46 and/or push surface 48 can be perpendicular to the central axis 44, or they can he at other angles, but either way they form a surface to effectively lock the anchor 40 in position.

In some embodiments, the anchor 40 defines a hole SO. A portion of the surface inside the hole faces towards the prosthetic tooth 30, and a portion faces away from the prosthetic tooth 30, so the hole 50 creates both a catch surface 46 and a push surface 48. The anchor 40 can comprise a plurality of holes 50, and the holes 40 should be shaped and positioned such that the anchor 40 retains structural integrity. In alternate embodiments, the anchor 40 comprises ridges 52, indentations 54, bumps 56, or other surface features. These ridges 52, indentations 54, or bumps 56 also have a surface that faces more towards the prosthetic tooth 30, and another surface that faces more away from the prosthetic tooth 30, and thereby creates a catch surface 46 and a push surface 48.

In some embodiments, the prosthetic tooth 30 is sized and shaped to replace two or more adjacent natural teeth 14 which are missing. The anchor 40 can extend from one or more of the connected and adjacent prosthetic teeth 30, or a single anchor 40 can extend from more than one adjacent, connected prosthetic teeth 30. Combining two or more adjacent prosthetic teeth 30 into a single structure can improve overall strength of the partial 10.

### Base

The base 60 is sized and shaped to conform to the inner surface 18 of the patient's mouth 12. When the partial 10 is in place, the base 60 conforms to and contacts at least part of the inner surface 18 of the patient's mouth 12, and may contact sonic or the entire facial surface of the gums 16. The base 60 can extend up to the teeth 14, 30, and stop at the side surface 31 of the teeth 14, 30, such as the lingual and/or facial surfaces 32, 34, or the mesial and distal surfaces 33, 35. In other embodiments, the base 60 extends underneath the palatal surface 38 of a prosthetic tooth 30. The base 60 is connected to the prosthetic teeth 30, and holds them in place.

The base 60 can include a clasp 62, which is a portion of the base 60 that clips into place about a natural tooth 14. The clasp 62 is sized and positioned to at least partially wrap around a natural tooth 14, and in some embodiments may wrap completely around a natural tooth 14. The clasp 62 secures the base 60, and therefore the entire partial 10, in place in the patient's mouth 12. Therefore, the clasp 62 secures the base 60 in a fixed position relative to the patient's natural tooth 14. A partial 10 can include one or more clasps 62 in various locations, as desired.

The base 60 is typically made of metal or a polymeric material, but other materials of construction are also possible. When a polymeric material is used, the polymeric material can be at least somewhat flexible. Many patients indicate a flexible polymeric base 60 is more comfortable than a metallic or ridged base 60, and comfort is important for a partial 10 that is used for multiple hours almost every day. The base 60 may also be a combination of different materials. For example, the base 60 may comprise a metal frame and a polymeric material, where the polymeric material covers the metal frame. The metal frame could provide rigidity and strength, and the polymeric material could provide a more comfortable fit to the patient's mouth 12. The metal frame could form the clasp 62, and the polymeric portion could form the portion of the base 60 contacting most of the patient's mouth 12. Other combinations are also possible, as well as other selections of base materials.

The anchor 40 is embedded in the base 60 such that the material of the base 60 contacts and abuts the catch surface 46 of the anchor 40. The material of the base 60 may also extend at least up to the edge or side surface 31 of the prosthetic tooth 30 with the anchor 40, so the prosthetic tooth 30 and anchor 40 are locked in position in the base 60. The material of the base 60 may also contact and abut the push surface of the anchor 40. Any motion of the anchor 40 parallel or in line with the central axis 44 causes either the catch surface 46 or push surface 48 (depending on the direction of movement) to move through the materials of the base 60 contacting that surface. Therefore, the prosthetic tooth 30 and anchor 40 are locked in position in the base 60. The abutment of the catch surface 46 and the material of the base 60 resists movement of the anchor 40 (and the attached prosthetic tooth 30) out of the base 60, and the abutment of the push surface 48 and/or the surface of the prosthetic tooth 30 with the base 60 resists movement of the anchor 40 and attached prosthetic tooth 30 into the base 60. The base 60 can be made of a flexible polymeric material, but the base 60 should be firm enough to resist detachment of the anchor 40.

In some embodiments, the anchor 40 is encased in the base 60, so the base 60 contacts the anchor 40 on all exposed surfaces. In some embodiments, the material of the base 60 passes through the hole 50 defined in the anchor 40, and the material of the base 60 contacts and abuts the catch and push surfaces 46, 48 on the sides of the hole 50. The base 60 may encase the ridges 52, indentations 54, or bumps 56 which may be part of the anchor 40, and thereby lock the anchor 40 in position in the base 60. If the anchor 40 is completely encased in the base 60, the anchor 40 cannot move in any direction within the base 60 without pushing through the base 60. If the anchor 40 is merely embedded in the base 60, the anchor 40 may have a surface that is not covered by the base 60, so there could be some motion that does not require the anchor 40 to pass through part of the base 60. Alternatively, the anchor 40 may be embedded in the base 60, but at least some of the base 60 covers each side of the anchor 40 so the anchor 40 is still locked in position in the base 60.

A prosthetic incisor tooth 30 can be held in place without any of the base 60 extending beyond the facial surface 32 of the prosthetic incisor tooth 30. The anchor 40 can extend from the lingual surface 34, and be embedded or encased in the base 60 to lock the prosthetic incisor tooth 30 in place. This can provide a strong, secure connection between the base 60 and the prosthetic incisor tooth 30, where the partial 10 is not visible when the patient smiles. The use of a unitary prosthetic tooth 30 and anchor 40, where the anchor 40 is embedded. in the base 60, provides a strong attachment and connection between the base 60 and the prosthetic tooth 30.

### Method of Production

The partial 10 described above can be custom made for an individual patient, so the unique structure and shape of the patient's mouth 12 is matched by the partial 10. A model is made of the patient's natural teeth 14 and gums 16, and other portions of the patient's mouth 12 as necessary. The model should be made after any required dental work for the patient. This model can be made by pressing a modeling material against the portions of the patient's mouth 12 that are to be modeled to make a reverse model. This can then he used to create an accurate reproduction or model of the desired portions of the patient's mouth 12.

One or more prosthetic teeth 30 are produced, where the prosthetic teeth 30 are sized and shaped to replace those missing in the patient. The use of an upper jaw model and a lower jaw model can help in the creation of prosthetic teeth 30 that do not interfere with the patient's natural bite. One or more of the prosthetic teeth 30 can be formed with a unitary anchor 40, as described above. The prosthetic tooth 30 and anchor 40 can include any or all of the features described. The prosthetic tooth 30 can be formed in a liquid or gel state that later sets up into a hard substance suitable for prosthetic teeth 30, or the base can be carved or formed from a pre-existing hard substance such as ivory. A cavity 42 can be molded into the prosthetic tooth 30 as it is formed, or the cavity 42 can be drilled or formed after the prosthetic tooth 30 is formed, if desired. Other features or aspects can also be created either while the material of the prosthetic tooth 30 is in a liquid state, or in a solid state.

A polymeric base 60 can be produced in a liquid state and poured or positioned as desired to fit the patient's mouth 12. The model can be used for this purpose. The liquid polymeric base material can flow around the anchor 40, through the holes 50, into the cavities 42, and wherever desired to produce the desired form, size, and shape. The liquid polymeric material can also flow around metallic portions of the base 60, if desired. The liquid polymeric material then cures or sets up into a solid structure for use. The liquid polymeric material can flow across the catch and push surfaces 46, 48 to make the desired abutment, and it can be urged around model natural teeth 14 to form the clasp 62.

Alternatively, the liquid polymer can be poured to form the base 60, and the prosthetic teeth 30 and anchors 40 can then be inserted into the polymer while still in a liquid or semi-liquid state. This can embed the anchor 40 in the base 60, or encase it, as desired. Metallic base components can also be formed and positioned using standard metal working techniques.

While the invention has been described with respect to a limited number of embodiments, those skilled in the art, having the benefit of this disclosure, will appreciate that other embodiments can be devised which do not depart from the scope of the invention as disclosed here. For example, this technique has been described for use with a dental partial 10, but a unitary prosthetic tooth 30 and anchor 40, where the anchor 40 is embedded in a base 60, could also be used in dentures or other dental products. Accordingly, the scope of the invention should be limited only by the attached claims.

1. A dental partial comprising:
(a) a prosthetic tooth having a lingual surface, where the prosthetic tooth primarily comprises zirconia;
(b) an anchor extending from the prosthetic tooth lingual surface, where the anchor is unitary with the prosthetic tooth, and where the anchor defines a plurality of holes; and
(c) a base sized and shaped to conform to a mouth inner surface, where the base comprises a flexible polymeric base material, where the anchor is encased in the base such that the flexible polymeric base material passes through the holes in the anchor.

2. The dental partial of claim 1 comprising a plurality of prosthetic teeth connected to the base.

3. The dental partial of claim 1 where the base comprises a clasp sized and positioned to abut a patient's natural tooth such that the clasp secures the base in a fixed position relative to patient's natural tooth.

4. The dental partial of claim 1 where the entire base is positioned posterior to a facial surface of a patient's incisor tooth.

5. A dental partial comprising:
a prosthetic tooth having a lingual surface and a facial surface;
(b) an anchor extending from at least one of the prosthetic tooth lingual surface and the prosthetic tooth facial surface, where the anchor is unitary with the prosthetic tooth; and
(c) a base sized and shaped to conform to a mouth inner surface, and where the anchor is embedded in the base.

6. The dental partial of claim 5 where the anchor defines a hole, and where the base passes through the hole.

7. The dental partial of claim 5 where the anchor comprises an axis and a catch surface, where the catch surface faces at least partially towards the prosthetic tooth relative to the axis, and the base contacts the catch surface.

8. The dental partial of claim 5 where the base encases the anchor.

9. The dental partial of claim 5 where the base comprises a flexible polymeric base material.

10. The dental partial of claim 5 where the prosthetic tooth and anchor primarily comprise zirconia.

11. The dental partial of claim 5 where the base comprises a clasp sized and positioned to wrap at least partially around a patient's natural tooth so the base is secured in place by the clasp and the patient's natural tooth.

12. The dental partial of claim 11 where the base comprises a flexible polymeric base material, and the clasp is formed form the flexible polymeric base material.

13. The dental partial of claim 5 where the entire base is positioned posterior to a patient's incisor tooth.

14. The dental partial of claim 5 where the prosthetic tooth comprises an incisor, and the entire base is posterior the facial surface of the prosthetic incisor tooth.

15. A method of producing a dental partial comprising:
(a) preparing a model of a patient's gums and teeth;
(b) producing a unitary prosthetic tooth and anchor, where the anchor extends from at least one of a facial surface and a lingual surface of the prosthetic tooth; and
(c) forming a base comprised of a flexible polymeric material, where the anchor is embedded in the base, and where the base is formed on the model so the base matches the contours of the patient's gums.

16. The method of claim 15 wherein (c) further comprises encasing the anchor in the flexible polymeric material.

17. The method of claim 15 Where the unitary prosthetic tooth and anchor primarily comprise zirconia.

18. The method of claim 15 where (b) further comprises forming a hole in the anchor, and wherein (c) further comprises framing the base such that the flexible polymeric material passes through the hole.

19. The method of claim 15 where (b) further comprises forming a catch surface on the anchor such that the catch surfaces faces towards the prosthetic tooth relative to an anchor axis, and where (c) further comprises positioning the flexible polymeric material in contact with the catch surface.

20. The method of claim 15 where the prosthetic tooth comprises an incisor, and where the entire base is positioned posterior to a facial surface of the prosthetic incisor tooth.
